(19) United States
(12) Patent Application Publication
(10) Pub. No.: US 2025/0251607 A1
(43) Pub. Date: Aug. 7, 2025

(54) VR silicone integrated headwear protective casing

(71) Applicant: Shenzhen Kunyang Technology Co., Ltd, Shenzhen (CN)

(72) Inventor: Xikun Fei, Hengyang (CN)

(21) Appl. No.: 18/432,166

(22) Filed: Feb. 5, 2024

(51) Int. Cl. G02B 27/01

(52) U.S. Cl. CPC G02B 27/0176

(57) ABSTRACT

A VR silicone integrated headwear protective casing is disclosed, including a protective casing body, a first strap, a second strap, and a third strap. The protective casing body has a first accommodation cavity used for accommodating a VR product, and one side of the protective casing body is configured with a first opening being connected to the first accommodation cavity. On the protective casing body, a window area corresponding to the VR product and a button area at least corresponding to a portion of the VR product are configured with pocket holes respectively. One end of the first strap is connected to the one side of the protective casing body, and one end of the second strap is connected to the other side of the protective casing body. By such designs, the VR silicone integrated headwear protective casing can wear more fit and comfortable, and more secure.

### TECHNICAL FIELD

The present application relates to the technical field of protective casings, and in particular to a VR silicone integrated headwear protective casing.

### BACKGROUND

Currently, a VR silicone integrated headwear protective casing generally has a plastic retractable structure, which is used to fix a VR product to a user's head. However this type of headwear protective casing is not tightly fitted to the user's head, resulting in uncomfortable. In addition, this type of headwear protective casing does not form a complete package on the VR product itself, and thus has a poor protective effect.

### SUMMARY

In view of technical problems discussed above, the present disclosure aims to provide a novelty VR silicone integrated headwear protective casing.

To achieve above objectives, the present disclosure adopts following technical solutions. In some embodiments of the present disclosure, a VR silicone integrated headwear protective casing is provided, including a protective casing body, a first strap, a second strap, and a third strap.

The protective casing body is configured with a first accommodation cavity used for accommodating a VR product, and one side of the protective casing body is configured with a first opening being connected to the first accommodation cavity. Herein on the protective casing body, a window area corresponding to the VR product and a button area at least corresponding to a portion of the VR product are configured with pocket holes respectively.

One end of the first strap is connected to the one side of the protective casing body, one end of the second strap is connected to the other side of the protective casing body, and the other end of the first strap is connected to the other end of the second strap.

One end of the third strap is connected to a top of the protective casing body and/or the VR product, and the other end of the third strap is configured with a first wearing portion used for the first strap and/or the second strap to be connected after being worn, and an enclosing cavity is formed by the first strap, the second strap and the third strap.

It can be seen that, in the VR silicone integrated headwear protective casing of the present disclosure, by setting the first accommodation cavity on the protective casing body for accommodating the entire VR product, so that the protective casing body is able to wrap the VR product as a whole, so as to play a role of protecting the VR product, and better protect it from collisions and scratches. In addition, the first strap and the second strap are connected to the protective casing body, as well as the third strap is also provided to connect the protective casing body and/or the VR product, so that the enclosing cavity can be formed between the first strap, the second strap, and the third strap, which is able to be fully wrapped for support around and on a top of the user's head, making the VR silicone integrated headwear protective casing of the present disclosure wear more fit and comfortable, and more secure.

In some preferred embodiments of the present disclosure, the first opening is configured with an arc part around perimeter thereof, and the arc part is configured to prevent the VR product from detaching the first accommodation cavity from the first opening.

In some preferred embodiments of the present disclosure, the first strap is configured with a first Velcro at one end away from the protective casing body, the second strap is configured with a second Velcro at one end away from the protective casing body, and the first Velcro and the second Velcro are adhered to each other.

In some preferred embodiments of the present disclosure, the first strap and the second strap each is configured with a second accommodation cavity at one end near the protective casing body, and the first strap and the second strap each is configured with a second opening connected to the second accommodation cavity.

In some preferred embodiments of the present disclosure, the third strap is configured with a first connecting part and a second connecting part at one end away from the protective casing body, and the first connecting part and the second connecting part are disposed at an angle. Moreover, the first connecting part and the second connecting part each is configured with the first wearing portion, the first strap passes through the first wearing portion on the first connecting part, and the second strap passes through the first wearing portion on the second connecting part.

In some preferred embodiments of the present disclosure, the third strap is configured with a third Velcro, the protective casing body and/or the VR product is configured with a second wearing portion, and the third strap is affixed to the third Velcro after passed through the second wearing portion.

In some preferred embodiments of the present disclosure, the protective casing body, the first strap, the second strap, and the third strap are made of silicone. And the protective casing body is integrally formed with the first strap and the second strap respectively.

In some preferred embodiments of the present disclosure, the first strap and/or the second strap is configured with a graduation line and the first wearing portion is configured to indicate the graduation line.

### BRIEF DESCRIPTION OF THE DRAWINGS

In order to more clearly illustrate the technical solutions in the embodiments of the present disclosure, the following will briefly introduce accompanying drawings that need to be used in the description of the embodiments or of existing technologies. It is obvious that the accompanying drawings in the following description are only some of embodiments of the present disclosure, and for one person of ordinary skill in the art, other drawings may be obtained according to these accompanying drawings without creative labor.

FIG. 1 is a structural schematic diagram of a VR silicone integrated headwear protective casing in accordance with some embodiments of the present disclosure.

FIG. 2 is another structural schematic diagram of the VR silicone integrated headwear protective casing in accordance with some embodiments of the present disclosure.

FIG. 3 is still another structural schematic diagram of the VR silicone integrated headwear protective casing in accordance with some embodiments of the present disclosure.

FIG. 4 is a structural schematic diagram of a third strap of the VR silicone integrated headwear protective casing in accordance with some embodiments of the present disclosure. In the drawings, reference signs are as follows.

100. Protective casing body, 110. First accommodation cavity, 120. Pocket hole, 130. Arc part, 140. Second accommodation cavity, 200. First strap, 210. First Velcro, 300. Second strap, 310. Second Velcro, 400. Third strap, 410. First connecting part, 420. Second connecting part, 430. First wearing portion, 440. Third Velcro, 500. Enclosing cavity, 600. Graduation line.

### DETAILED DESCRIPTION OF THE EMBODIMENTS

In order to make the technical problems, technical solutions, and beneficial effects to be solved by the present disclosure more clear and understandable, the present disclosure is hereafter described in further detail in conjunction with accompanying drawings and embodiments. It should be understood that specific embodiments described herein are only intended to explain the present invention and are not intended to limit the present invention.

It is noted that when an element is referred to as being “secured to” or “disposed on” the other element, it may be directly on the other element or indirectly on the other element. When an element is said to be “connected to” the other element, it may be directly connected to the other element or indirectly connected to the other element.

It should be understood that, terms “length”, “width”, “upper”, “lower”, “front”, “rear”, “left”, “right”, “vertical”, “horizontal”, “top”, “bottom”, “inside”, and “outside”, and the like indicate orientations or positional relationships based on those shown in the accompanying drawings, and are only for the purpose of facilitating the description of the present disclosure and simplifying the description, and are not indicated or implied that a device or an element must be constructed and operated in a particular orientation and are not to be understood as limitations of the present invention.

Furthermore, terms “first” and “second” are used for descriptive purposes only and are not to be understood as indicating or implying relative importance or as implicitly specifying the quantity of technical features indicated. Thus, a feature defined as “first”, or “second” may expressly or impliedly include one or more such features. In addition, in some descriptions of the present disclosure, “more than one” means two or more, unless otherwise expressly specified.

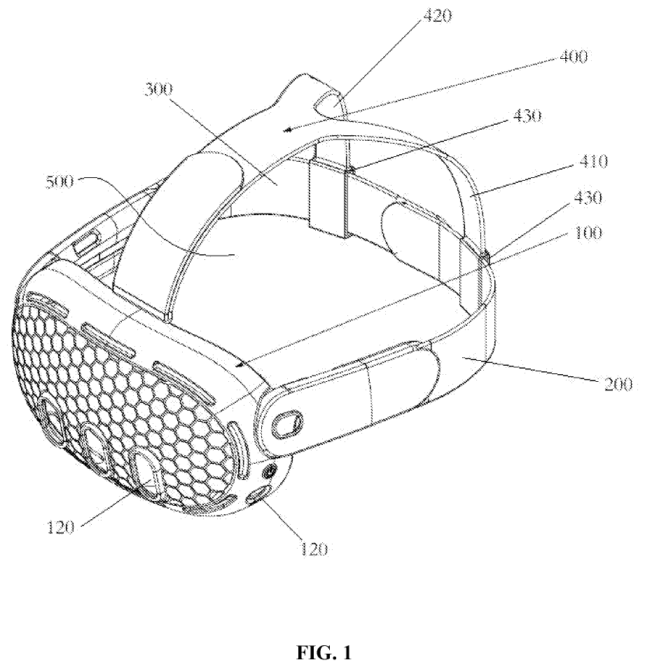

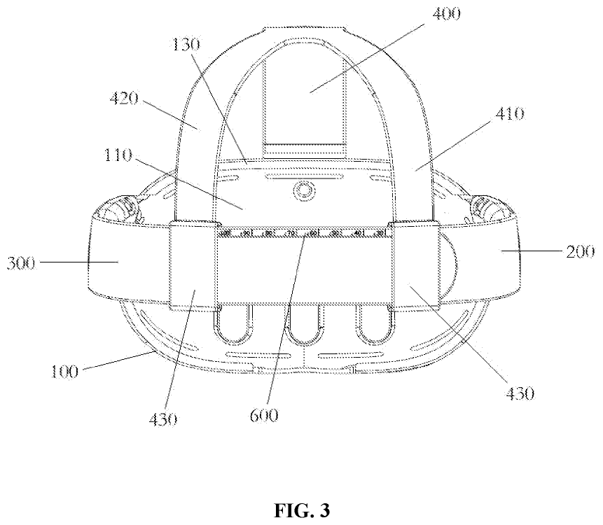

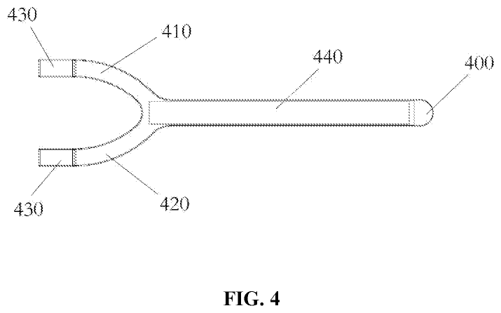

Referring to FIG. 1 to FIG. 4, in some embodiments of the present disclosure, a VR silicone integrated headwear protective casing is provided, including a protective casing body 100, a first strap 200, a second strap 300, and a third strap 400.

Herein, the protective casing body 100 has a first accommodation cavity 110 (not shown in figures) used for accommodating a VR product, and one side of the protective casing body 100 is configured with a first opening being connected to the first accommodation cavity 110. The VR product may be fitted within the first accommodation cavity 110 through the first opening such that the protective casing body 100 protects the entire VR product.

Furthermore, on the protective casing body, a window area corresponding to the VR product and a button area at least corresponding to a portion of the VR product are configured with pocket holes 120 respectively.

One end of the first strap 200 is connected to the one side of the protective casing body 100, one end of the second strap 300 is connected to the other side of the protective casing body 100, and the other end of the first strap 200 is connected to the other end of the second strap 300. In this way, the first strap 200 and the second strap 300 are able to secure the VR product to a back of a user's head after being connected to each other.

One end of the third strap 400 is connected to a top of the protective casing body 100 and/or the VR product, and the other end of the third strap 400 is configured with a first wearing portion 430. Herein the first wearing portion 430 may be a threading hole, and the first wearing portion 430 is used for the first strap 200 and/or the second strap 300 to be connected after being worn, so that an enclosing cavity 500 is formed by the first strap 200, the second strap 300, and the third strap 400. The enclosing cavity 500 can provide a fully wrapped support around and on a top of the user's head, making the VR silicone integrated headwear protective casing wear more fit, comfortable, and more secure.

It can be seen that, in the VR silicone integrated headwear protective casing of the present disclosure, by setting the first accommodation cavity 110 on the protective casing body 100 for accommodating the entire VR product, so that the protective casing body 100 is able to wrap the VR product as a whole, so as to play a role of protecting the VR product, and better protect it from collisions and scratches. In addition, the first strap 200 and the second strap 300 are connected to the protective casing body 100, as well as the third strap 400 is also provided to connect the protective casing body 100 and/or the VR product, so that the enclosing cavity 500 can be formed between the first strap 200, the second strap300, and the third strap 400, which is able to be fully wrapped for support around and on the top of the user's head, making the VR silicone integrated headwear protective casing of the present disclosure wear more fit and comfortable, and more secure.

Furthermore, the first opening is configured with an arc part 130 around perimeter thereof, and the arc part 130 is configured to prevent the VR product from detaching the first accommodation cavity 110 from the first opening. The arc part 130 may be integrally molded with the protective casing body 100.

The first strap 200 is configured with a first Velcro 210 at one end away from the protective casing body 100, the second strap 300 is configured with a second Velcro 310 at one end away from the protective casing body 100, and the first Velcro 210 and the second Velcro 310 are adhered to each other. The first Velcro 210 and the second Velcro 310 may facilitate attachment between the first strap 200 and the second strap 300, while also facilitating adjustment of sizes of the first strap 200 and the second strap 300 when surrounding the user's head.

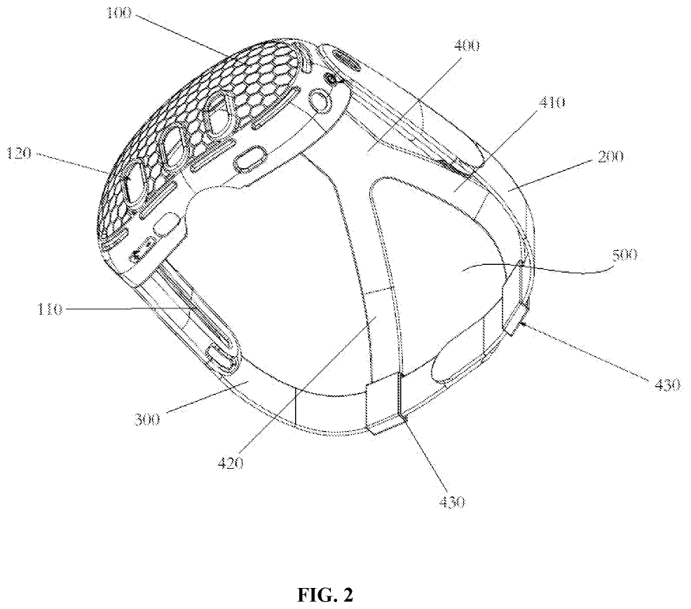

Referring to FIG. 2, in some embodiments of the present disclosure, the first strap 200 and the second strap 300 each is configured with a second accommodation cavity 140 at one end near the protective casing body 100, and the first strap 200 and the second strap 300 each is configured with a second opening connected to the second accommodation cavity 140.

It will be appreciated that in some embodiments of the present disclosure, both sides of the VR product may include horn portions protruded provided, so that when the VR product provided with the horn portions installs the horn portions into the second accommodation cavity 140 through the second opening, the horn portions can be protected by the VR product.

Referring to FIG. 1 to FIG. 4, the third strap 400 is configured with a first connecting part 410 and a second connecting part 420 at one end away from the protective casing body 100, and the first connecting part 410 and the second connecting part 420 are disposed at an angle. The first connecting part 410 and the second connecting part 420 each is configured with the first wearing portion 430, the first strap 200 passes through the first wearing portion 430 on the first connecting part 410, and the second strap 300 passes through the first wearing portion 430 on the second connecting part 420. In this way, connections between the third strap 400 and the first strap 200 and the second strap 300 respectively are realized, thereby facilitating the ability to enable formation of the enclosing cavity 500 between the first strap 200, the second strap 300, and the third strap 400.

With reference to FIG. 1 to FIG. 3, the third strap 400 is further configured with a third Velcro 440, the protective casing body 100 and/or the VR product is configured with a second wearing portion, herein the second wearing portion may be the threading hole, and the third strap 400 is affixed to the third Velcro 440 after passed through the second wearing portion. This design can, on the one hand, facilitate connection of the third strap 400 to the protective casing body 100 and/or the VR product, and on the other hand, a length of the third strap 400 can be easily adjusted to adapt to people with different head circumferences, thereby improving compatibility of the VR silicone integrated headwear protective casing of the present disclosure.

In some embodiments of the present disclosure, the protective casing body 100, the first strap 200, the second strap 300, and the third strap 400 are made of silicone, thereby having good elasticity, and can improve use experiences of the VR silicone integrated headwear protective casing of the present disclosure, making it more fitting and more comfortable. In addition, it is also convenient to wash with water, convenient to clean, safe and environmentally friendly, and has a long service life.

Furthermore, the protective casing body 100 is integrally formed with the first strap 200 and the second strap 300 respectively. In this way, reliability and the service life of the VR silicone integrated headwear protective casing of the present disclosure can be improved, and rivet structures for connecting the first strap 200 and the second strap 300 to the protective casing body 100 respectively also can be reduced, so as to avoid rivets from scratching skins.

Furthermore, the first strap 200 and/or the second strap 300 is configured with a graduation line 600, and the first wearing portion 430 is configured to indicate the graduation line 600.

For example, when the first strap 200 is configured with the graduation line 600, during the first strap 200 passes through the first wearing portion 430, an edge of the first wearing portion 430 may indicate the graduation line 600 on the first strap 200. And when the first strap 200 and the second strap 300 are adhered through the first Velcro 210 and the second Velcro 310, requirements of the user's length may be memorized with reference to the graduation line 600, making it easy to quickly find one's own suitable length for adhering in next time, which can improve convenience.

The above is only some preferred embodiments of the present disclosure, and is not intended to limit the present invention. Any modifications, equivalent substitutions and improvements made within conceptions and principles of the present invention shall be covered in the scope of protection of the present invention.

What is claimed is:

1. A VR silicone integrated headwear protective casing, comprising
a protective casing body, configured with a first accommodation cavity used for accommodating a VR product, and one side of the protective casing body is configured with a first opening being connected to the first accommodation cavity;
wherein on the protective casing body, a window area corresponding to the VR product and a button area at least corresponding to a portion of the VR product are configured with pocket holes respectively;
a first strap and a second strap, wherein one end of the first strap is connected to the one side of the protective casing body, one end of the second strap is connected to the other side of the protective casing body, and the other end of the first strap is connected to the other end of the second strap; and
a third strap, one end of the third strap is connected to a top of the protective casing body or the VR product, and the other end of the third strap is configured with a first wearing portion used for the first strap and the second strap to be connected after being worn, and an enclosing cavity is formed by the first strap, the second strap, and the third strap.

2. The VR silicone integrated headwear protective casing according to claim 1,
wherein the first opening is configured with an arc part around perimeter thereof, and the arc part is configured to prevent the VR product from detaching the first accommodation cavity from the first opening.

3. The VR silicone integrated headwear protective casing according to claim 1,
wherein the first strap is configured with a first Velcro at one end away from the protective casing body, the second strap is configured with a second Velcro at one end away from the protective casing body, and the first Velcro and the second Velcro are adhered to each other.

4. The VR silicone integrated headwear protective casing according to claim 1,
wherein the first strap and the second strap each is configured with a second accommodation cavity at one end near the protective casing body, and the first strap and the second strap each is configured with a second opening connected to the second accommodation cavity.

5. The VR silicone integrated headwear protective casing according to claim 1,
wherein the third strap is configured with a first connecting part and a second connecting part at one end away from the protective casing body, and the first connecting part and the second connecting part are disposed at an angle; and
wherein the first connecting part and the second connecting part each is configured with the first wearing portion, the first strap passes through the first wearing portion on the first connecting part, and the second strap passes through the first wearing portion on the second connecting part.

6. The VR silicone integrated headwear protective casing according to claim 1,
wherein the third strap is configured with a third Velcro, the protective casing body or the VR product is configured with a second wearing portion, and the third strap is affixed to the third Velcro after passed through the second wearing portion.

7. The VR silicone integrated headwear protective casing according to claim 1,
wherein the protective casing body, the first strap, the second strap, and the third strap are made of silicone; and
wherein the protective casing body is integrally formed with the first strap and the second strap respectively.

8. The VR silicone integrated headwear protective casing according to claim 5,
wherein the first strap or the second strap is configured with a graduation line and the first wearing portion is configured to indicate the graduation line.
